(19) United States
(12) Patent Application Publication
(10) Pub. No.: US 2017/0166215 A1
(43) Pub. Date: Jun. 15, 2017

(54) VEHICLE CONTROL SYSTEM USING TIRE SENSOR DATA

(71) Applicant: Uber Technologies, Inc., San Francisco, CA (US)

(72) Inventor: Peter Rander, Pittsburgh, PA (US)

(21) Appl. No.: 15/376,270

(22) Filed: Dec. 12, 2016

Related U.S. Application Data
(60) Provisional application No. 62/265,960, filed on Dec. 10, 2015.

(51) Int. Cl. B60W 40/064; G07C 5/00; G01C 21/28; B60T 8/172

(52) U.S. Cl. CPC B60W 40/064; B60T 8/1725; G07C 5/008; G01C 21/28; B60W 2422/70; B60W 2750/40; B60W 2530/20

(57) ABSTRACT

An automated or autonomous vehicle obtains measurements from at least a first tire sensor, where the measurements reflect a grip state and/or grip margin. The tire sensor information be synchronized with location information, identifying a location where the tire sensor information was obtained.

### RELATED APPLICATIONS

This application claims benefit of priority to Provisional U.S. Patent Application No. 62/265,960, filed Dec. 10, 2015; the aforementioned priority application being hereby incorporated by reference in its respective entirety.

### TECHNICAL FIELD

Examples described herein relate to vehicle control systems, and more specifically, to a vehicle control system which utilizes tire sensor data.

### BACKGROUND

Increasingly, automation is used to control vehicles for a variety of purposes, such as collision aversion, parking, and autonomous driving. With human drivers, the role of automation is to increase safety and to facilitate the human driver. Fully autonomous vehicles, on the other hand, replace human drivers with sensors and computer-implemented intelligence, sensors and other automation technology. Autonomous vehicles, whether fully autonomous or hybrid (collectively referred to as “automated vehicles”), represent a significant advancement in automation technology. For example, automated vehicles require a diverse and sophisticated range of sensors and sensor processing resources to interpret the environment which the vehicles are moving in. Moreover, automated vehicles require advanced decision-making abilities, given the plethora of inputs that are perceptible at a given moment, as well as understanding events or conditions which may be imminent, but not necessarily perceptible without unless there is a deeper understanding. Additionally, automated vehicles require advanced control processes for translating a digital output of a computer into physical actions.

Despite years of research and development, it is only with recent technological advances that automated vehicles have developed into a form that is sufficiently operable to be useful and safe.

### BRIEF DESCRIPTION OF THE DRAWINGS

FIG. 1 illustrates an example vehicle that is adapted to utilize tire sensor data, according to some embodiments.

FIG. 2 illustrates an example of a control system for an autonomous vehicle.

FIG. 3 is a block diagram that illustrates a server system for providing a network service that utilizes tire sensor data.

FIG. 4 illustrates an example of an autonomous vehicle that can operate to transmit and receive location-specific tire sensor information.

FIG. 5 is a block diagram that illustrates a control system for an autonomous vehicle upon which embodiments described herein may be implemented.

FIG. 6 illustrates a method for operating a vehicle to provide location-specific tire sensor data to a network service.

FIG. 7 illustrates a method for operating a vehicle to in a manner that anticipates changes to tire grip.

FIG. 8 illustrates an example method for developing a road surface map of a given geographic region, according to one or more examples.

### DETAILED DESCRIPTION

Examples include a vehicle control system that is adapted to utilize tire sensor data. Still further, some examples include a vehicle that utilizes measured and/or anticipated tire sensor data to control or configure operations of an automated vehicle. The vehicle, which can be a vehicle in a fleet of vehicles, can provide data, based at least in part on the tire sensor data, to a remote computing system, which can then control other vehicles using the received data.

According to one example, an automated or autonomous vehicle obtains measurements for at least a first tire sensor of the autonomous vehicle, where the measurements reflect a grip state and/or grip margin. While the vehicle is operated and measurements are received, the vehicle logic may synchronize the location information with the tire sensor data to create location-specific grip values.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Numerous examples are referenced herein in context of an autonomous vehicle. An autonomous vehicle refers to any vehicle which is operated in a state of automation with respect to steering and propulsion. Different levels of autonomy may exist with respect to autonomous vehicles. For example, some vehicles today enable automation in limited scenarios, such as on highways, provided that drivers are present in the vehicle. More advanced autonomous vehicles drive without any human driver inside the vehicle. Such vehicles often are required to make advance determinations regarding how the vehicle is behave given challenging surroundings of the vehicle environment.

System Description

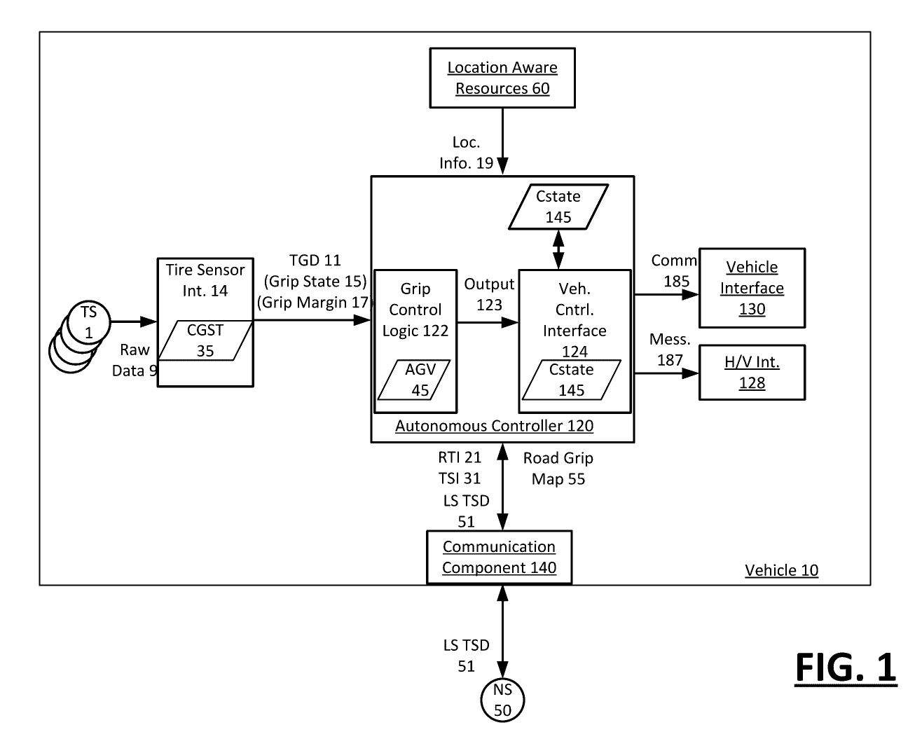

FIG. 1 illustrates an example vehicle that is adapted to utilize tire sensor data, according to some embodiments. A vehicle 10, in accordance with examples such as described with FIG. 1, can correspond to either an autonomous vehicle, a human-driven vehicle, or an autonomous-human hybrid. In an example of FIG. 1, a vehicle 10 includes an autonomous controller 120, a vehicle interface 130, and a communication component 140.

The autonomous controller 120 can process sensor input from a variety of sensor sources in order to control at least some aspects of the vehicle's operation. In examples provided, an output of the autonomous controller 120 corresponds to commands 185, representing instructions or parametric data provided to the vehicle interface 130 for purpose of controlling the vehicle 10. The vehicle interface 130 can include one or more electromechanical components which translate data into implementation or control of vehicle control actions based on input of the autonomous controller 120. For example, the vehicle interface 130 can implement, facilitate or influence a braking or acceleration action.

As described with various examples, the vehicle 10 utilizes a set of tire sensors 1 in order to obtain tire sensor data 11, from which some vehicle control operations can be determined or influenced. By way of example, the commands 185 can change the speed of the vehicle, adjust a turning radius when the vehicle 10 is in turn, adjust braking strength for stopping the vehicle, adjust spacing the vehicle relative to other objects of the road, and/or implement a vehicle action such as lane aversion or selection. In alternative variations, the commands 185 are implemented by autonomous vehicles or automated facets of human driven vehicles. For example, the vehicle 10 can correspond to a human driven vehicle that utilizes automation for purpose of enabling safety features (e.g., collision avoidance) or driver assistance (e.g., self-driving mode on highways). In variations, the vehicle 10 can be fully autonomous, so that no driver occupies the vehicle.

In some variations, the autonomous controller 120 can also generate messages 187 for a human vehicle interface (“H/V interface 128”), to enable content of the messages to be viewed or consumed by humans. As described with some examples, the autonomous controller 120 can include functionality that determines anticipated tire grip values and parameters from remote sources for portions of a road that the vehicle 10 is about to or likely to traverse across. The autonomous controller 120 can also utilize current tire sensor data, as measured from tire sensors 1, to make determinations for controlling the vehicle based on present time conditions. Still further, some examples implement vehicle control actions based on a comparison or change of current tire sensor values (e.g., grip state, grip margin) as compared to anticipated tire sensor values.

According to some examples, the tire sensors 1 can correspond to sensors which are embedded within treads or integrated inside of the tires to measure a degree of contact between the tire and an underlying road (termed “tire grip” or “grip”). The degree of contact (or grip) may be based on the force of contact between a tire and road. The “grip value” may reflect a quantification of the amount of contact between tire and road. It is generally understood that the more grip a given tire has with respect to an underlying road (meaning greater grip value), the greater the coefficient of friction between the tire and the road, the greater the force of the tire on the road, and the greater the amount of tire which contacts the road. Thus, the more grip a given tire has with respect to the underlying road, the more control the vehicle can have for purpose of performing actions that require lateral or forward and backward acceleration. Examples further recognize that there is a point at which a tire loses grip so as to lose contact with the road, resulting in the vehicle losing control. For example, at one extreme, a tire without any grip is not in contact with the underlying road. An example of a no-grip scenario is when a tire is said to “hydroplane” on water or liquid. Prior to a point of no-grip, examples recognize that a tire can lose grip and still be in contact with the road. But at a given grip safety threshold or point, the amount of contact is deemed insufficient for safety purposes. Moreover, examples recognize that the less grip a set of tires have with respect to the road, the less ability the vehicle 10 has to perform operations which require lateral of forward/backward acceleration.

The grip value has a correlation to a determination of coefficient of friction, as between the tire and an underlying road. The coefficient of friction between tire and road may also be affected by other factors, such as precipitation, snow, and/or type of road. Examples recognize that the grip value, as measured through tire sensors, can be correlated to a determination of coefficient of friction.

In an example shown, the set of tire sensors 1 are provided on the vehicle 10 to generate raw sensor data 9. Multiple sets of tire sensors 1 can be provided on the vehicle 10. For example, a set of tire sensors 1 can be provided on each tire of the vehicle 10, or alternatively, on front tires or rear-tires or just on one tire. In one implementation, tire sensor interface 14 includes logic to process and interpret the raw sensor data 9 tire sensor data 11. The raw sensor data 9 can include or correlate to values for multiple parameters (e.g., temperature, force etc.) which directly or indirectly relate to the amount of contact between tire and road. According to one example, the tire sensor data 11 indicates (i) a grip state 15 of a corresponding tire with respect to a road, and (ii) a grip margin 17 of the corresponding tire to a grip safety threshold after which the vehicle is deemed unsafely in motion. The grip state 15 can correspond to one of multiple possible ranges for the grip value, while the grip margin 17 may reflect a determination of the proximity between the tire's grip and the tire's grip safety threshold 35. The grip safety threshold 35 can reflect a value where there is no grip by the tires (e.g., hydroplaning), or a value set below that extreme, as designed by default or preference. In some examples, the grip state 15 can reflect a grip value that is either within a safety margin or outside of the safety margin. In variations, more granular determinations can be made for grip state, such as a highly gripped state, a moderate grip state, low grip state, and grip state outside of safety threshold. Still further, a measure of the grip value can reflect the grip state 15.

In some examples, the tire sensor interface 14 can be a separate or external component to the autonomous controller 120, so that the autonomous controller 120 receives tire sensor data 11 from the tire sensor interface 14. In variations, at least some of the functionality attributed to the tire sensor interface 14 (e.g., interpreting the tire data 11, determining the grip state 15 and grip margin 17) can be integrated with the autonomous controller 120.

According to some examples, the autonomous controller 120 includes grip control logic 122 and vehicle control interface 124. The grip control logic 122 can evaluate and make determinations based on (i) a vehicle's current set of grip values (e.g., grip state 15, grip margin 17), and (ii) an anticipated set of grip-related values (“grip differential 45” or “anticipated grip value 45”) for a road segment that the vehicle is anticipated to traverse. The grip differential 45 can be based on, for example, an anticipated grip state, grip margin and/or grip safety threshold. The grip differential 45 can reflect grip values which are stored in a memory of the vehicle 10 from a previous use of the vehicle. Alternatively, the grip differential 45 can be obtained from an external source, such as a network service (e.g., road surface map for a given region). In variation, the grip differential 45 can also include or be based on non-tire sensor measured parameters, such as resulting from puddles or rain. The output 123 of the grip control logic 122 can be communicated to the vehicle control interface 124.

The vehicle control interface 124 can generate one or more commands 185 based in part on the output 123 of the grip control logic 122. The output 123 can also be based in part on a comparison between a current set of grip values (e.g., grip state 15, grip margin 17) and anticipated grip values (e.g., after application of the grip differential 45). In some examples, a comparison of current and anticipated grip values can influence a driving model or other programmatic process for operating the vehicle, taking into account parameters such as speed, anticipated braking distance and lane selection.

In some examples, the vehicle control interface 124 can maintain, for example, a current state 145 of one or more control mechanisms of the vehicle for purpose of controlling the vehicle. In such examples, the vehicle control interface 124 can make determinations as to when the current state 145 of the vehicle should be changed based on inputs to the driving model, including those which may make changes to the current state of the vehicle. In response to the determinations and/or current state change, vehicle control interface 124 can issue commands 185 which can be implemented by vehicle interface component 130 in order to control an aspect of the vehicle's operation, such as velocity, vehicle turning radius, braking distance, or lane aversion or selection.

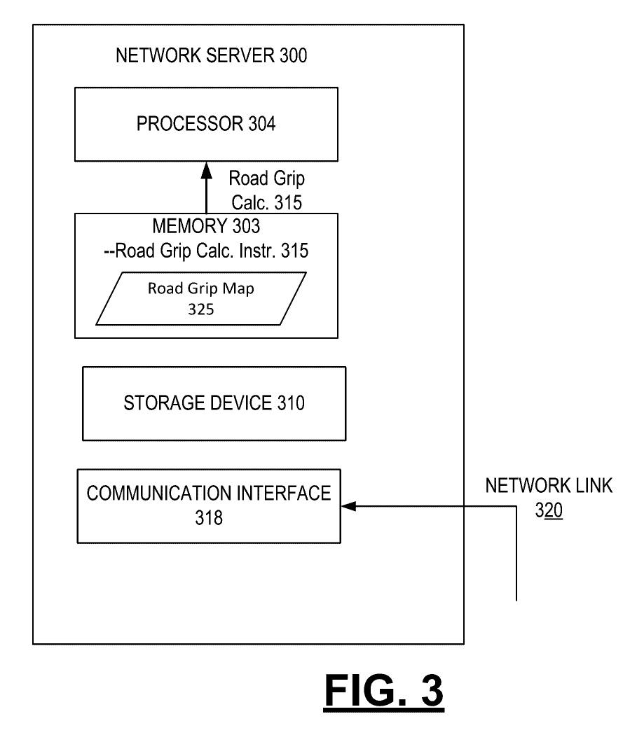

While the tire sensor data 11 can indicate a current set of grip values, the grip control logic 122 can estimate a change represented by the grip differential 45, given the current trajectory, path or route of the vehicle 10. In some examples, the parameters for the grip differential 45 can be calculated on the vehicle 10 from information provided relating to an upcoming route segment that the vehicle is to operate on. With reference to an example of FIG. 1, the grip differential 45 can be determined in part from remotely acquired road-tire interface (“RTI”) information 21. The (“RTI”) information 21 can reflect information from sources other than tire sensors, such as weather related information or driving conditions reported from other vehicles on the road. For example, the RTI information 21 can include a parametric value that reflects a determination that a portion of a road segment that the vehicle 10 is about to ride over has water, oil or other condition that will negatively affect the grip state 15 of the vehicle's tires. The RTI information 21 can, for example, be in the form of a weight, a scalar or a probability value. The RTI information 21 can be obtained from a variety of sources, such as a network service (e.g., such as provided by a computer system of an example of FIG. 3), or through public information sources on the Internet. In some examples, the RTI information 21 is determined on the vehicle 10 from data provided by one or more remote sources. In variations, the RTI information 21 is determined off-vehicle, such as on a network service and then communicated to the vehicle 10.

In variations, the RTI information 21 can include tire sensor information 31 of other vehicles. The tire sensor information 31 of other vehicles can be obtained through interaction with remote communication sources, such as with other vehicles or with a network service. In some implementations, the tire sensor information 31 can be received from multiple sources, and then aggregated and/or analyzed before being communicated to the vehicle 10 as RTI information 21. Still further, as described with some examples, the processed tire sensor information 31 can correspond to a road road surface map 55 reflecting tire sensor information 31 that is location-specific and aggregated from one or multiple vehicles during a relevant time period. As described with some examples, the road surface map 55 may reflect tire sensor measurements from other vehicles that traverse a given roadway. The road surface map 55 can normalize measured grip values to reflect, for example, a common tire dimension, tread, size, air pressure etc.

According to some examples, the vehicle 10 can be representative of a vehicle that operates as both an information source and sink with regards to tire sensor information. As an information sink, the vehicle 10 receives RTI information 21, including tire sensor information 31, from a network service 50 using the communication component 140. The tire sensor information 31 can represent data measured by tire sensors of other vehicles for segments of a route on which the vehicle 10 is being operated on. The tire sensor information 31 can include directly measured data, such as the tire sensor data 11, as well as extrapolated information, such as provided by the grip state 15 and tire grip margin 17 of tire sensor information 31 accumulated from other vehicles.

In some variations, the autonomous controller 120 receives tire sensor information 31 that is based on, or otherwise provided with contextual information, including operational parameters (e.g., velocity, acceleration etc.) of the vehicle which provide the tire sensor information 31. Still further, the tire sensor information 31 can represent an aggregation of values from multiple vehicles, such as an average or approximation of tire sensor data acquired by multiple vehicles over a given road segment. By way of example, the tire sensor information 31 can include grip safety threshold parameters, which provide a measure or approximation of how much a current roadway condition affects the grip safety threshold of tires in general (e.g., “low grip” or “high grip” tire slippage areas).

Still further, in some variations, the network service 50 provides the vehicle 10 with tire sensor information 31 to enable determination of one or more parameters of the grip differential 45. In some examples, the network service 50 can communicate through the communication component 140 to provide the vehicle 10 with actual grip values (e.g., grip state or margin), as measured from one or more vehicles (e.g., through use of tire sensors) during a relevant time period (e.g., same day), for an approaching road segment.

Still further, in some variations, the network service 50 can communicate through the communication component 140 to provide the vehicle 10 with a road surface map 55 that reflects road grip values at multiple locations relevant to the vehicle 10. For example, the road surface map 55 can populate locations of a map with grip values, including grip state and grip margin as measured by tire sensors provided on individual vehicles in a population. The grip control logic 122 can use the RTI information 21, including tire sensor information 31, and/or the road surface map 55, in order to determine a set of anticipated grip values 45 for one or multiple locations of a route segment on which the vehicle 10 is likely or imminently to traverse across.

According to some examples, the network service 50 can be implemented through a combination of servers which communicate with vehicles in a given geographic region. In variations, the network service 50 can correspond to another vehicle, or to a mobile computing device of a user (e.g., operator or passenger of the vehicle). As with other examples, the network service 50 can process (e.g., aggregate, analyze) and transmit tire sensor information 31 to a number of vehicles 10 in a given geographic region. By way of example, variations provide for the communication component 140 to implement one of a wireless network link to a network service operated by one or more servers, a local link to a mobile computing device of a user or driver, or a point-to-point link to another vehicle.

When the vehicle 10 operates as an information source, the vehicle 10 can communicate location-specific tire sensor data 51 to the network service 50. The location-specific tire sensor data 51 can combine tire sensor data 11, including the vehicle's current grip state 15 and grip margin 17, with location information 19 as provided by a location aware resource 60 of vehicle 10. As provided with examples, the location information 19 can, for example, be GPS derived, and location information provided by such resources may be granulized to an extent permitted with GPS technology. In variations, the location information 19 can be highly localized with the use of additional sensors, such as provided with depth cameras or laser-sighted optical sources. In some implementations, the location information 19 can granulized to be specific to a location that is of an order of a foot, or approximately a width of the size of a tire. The grip control logic 122 can merge or otherwise synchronize the location information 19 with the tire sensor data 11 (including grip state 15 or grip margin 17), in order to generate the location-specific tire sensor data 51. The location-specific tire sensor data 51 can thus provide a tire sensor data set that is associated with location information 19 that reflects a location of a road from which measurements are made through tire sensor(s) 1.

In some examples, the output 123 of the grip control logic 122 can be parametric, to reflect, for example, an adjustment or modification to an existing or anticipated action. For example, the output 123 of the grip control logic 122 can be represented as one or more parameters that reflect an appropriate or optimal braking distance or turning radius. The vehicle control interface 124 can maintain a current state 145 of the vehicle, such as whether the vehicle is in a state of braking or turning, or a planned braking distance of the vehicle at the current instance (e.g., distance the vehicle maintains with a vehicle). The vehicle output interface 124 can signal commands 185 to the vehicle interface 130 to implement a vehicle action that changes the current state of the vehicle, based on the output 123 of the grip control logic 122.

By way of example, the tire sensor data 11 at a particular instance in time can provide a specific grip state 15 and grip margin 17. The grip control logic 122 can generate the output 123 as a set of parameters which reflect, for example, (i) a weight or adjustment factor for an ideal stopping distance of the vehicle, given the current grip state and grip margin 17, as well as the anticipated grip value 45; and (ii) roadway conditions, such as provided by ice, snow, precipitation, or other environmental factors which may affect the roadway condition. The vehicle control interface 124 can adjust a current state 145 of the vehicle 10 when driven. In some variations, the vehicle control interface 124 can issue commands 185 to implement planning actions, such as increasing or decreasing the stopping distance or separation distance with the vehicle in front. If the vehicle 10 is in process of implementing an action, the output 123 can adjust or influence performance of the action. For example, if the vehicle is in the process of braking and the grip control logic 122 determines that the anticipated grip values 45 will suddenly worsen, the output 123 of the grip control logic 122 may cause the vehicle control interface 124 to issue commands 185 to reduce, for example, the magnitude of the braking action.

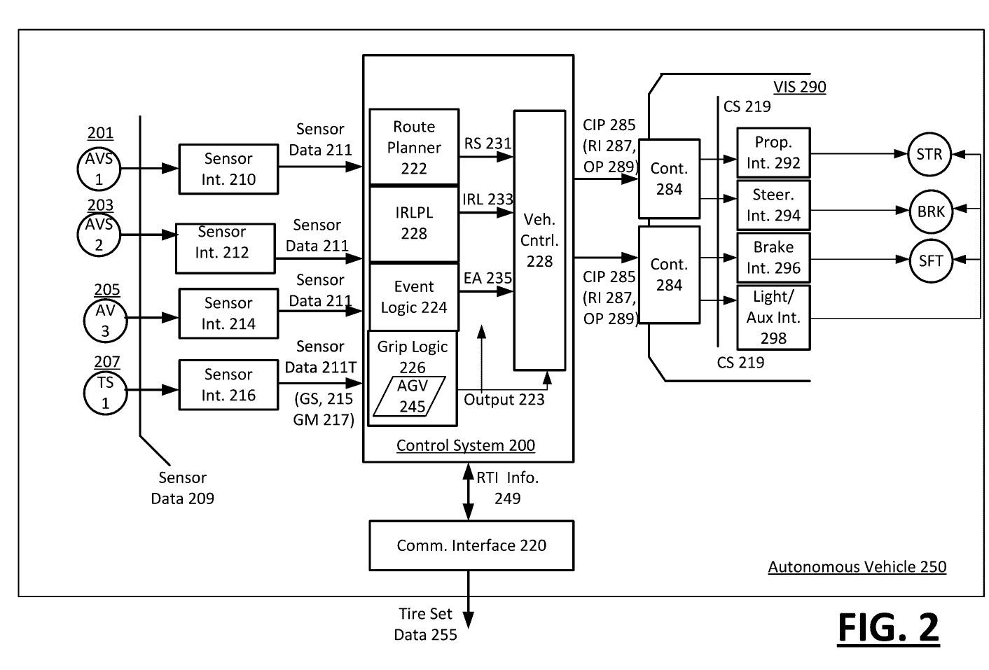

FIG. 2 illustrates an example of a control system for an autonomous vehicle. In an example of FIG. 2, a control system 200 is provided as an open system that can function to autonomously operate a vehicle 250. The control system 200 can operate the autonomous vehicle 250 in a given geographic region for a variety of purposes, including transport services (e.g., transport of humans, delivery services, etc.). In examples described, the autonomously driven vehicle 250 can operate without human control. For example, in the context of automobiles, the autonomously driven vehicle 250 can steer, accelerate, shift, brake and operate lighting components. Some variations also recognize that an autonomous-capable vehicle can be operated either autonomously or manually. Accordingly, examples described in context of the autonomous vehicle 250 can also extend to autonomous-capable vehicles which can intermittingly be driven without human intervention, but generally carry a driver.

In one implementation, the control system 200 can utilize specific sensor resources in order to intelligently operate the vehicle 250 in most common driving situations. For example, the control system 200 can operate the vehicle 250 by autonomously steering, accelerating and braking the vehicle 250 as the vehicle progresses to a destination. The control system 200 can perform vehicle control actions (e.g., braking, steering, accelerating) and route planning using sensor information, as well as other inputs (e.g., transmissions from remote or local human operators, network communication from other vehicles, etc.).

In an example of FIG. 2, the control system 200 includes a computer or processing system which operates to process sensor data that is obtained on the vehicle with respect to a road segment that the vehicle is about to drive on. The sensor data can be used to determine actions which are to be performed by the vehicle 250 in order for the vehicle to continue on a route to a destination. In some variations, the control system 200 can be coupled with communication interface 220 to enable wireless communication capabilities, including to send and/or receive wireless communications with one or more remote sources. In controlling the vehicle, the control system 200 can issue instructions and data, shown as commands 285, which programmatically controls various electromechanical interfaces of the vehicle 250. The commands 285 can serve to control operational aspects of the vehicle 250, including propulsion, braking, steering, and auxiliary behavior (e.g., turning lights on).

The autonomous vehicle 250 can be equipped with multiple types of sensors 201, 203, 205, 207 which combine to provide a computerized perception of the space and environment surrounding the vehicle 250. Likewise, the control system 200 can operate within the autonomous vehicle 250 to receive sensor data from the collection of sensors 201, 203, 205, 207 and to control various electromechanical interfaces for operating the vehicle on roadways.

In more detail, the sensors 201, 203, 205, 207 operate to collectively obtain a complete sensor view of the vehicle 10, and further to obtain information about what is near the vehicle, as well as what is near or in front of a path of travel for the vehicle. By way of example, the sensors 201, 203, 205, 207 include multiple sets of cameras sensors 201 (video camera, stereoscopic pairs of cameras or depth perception cameras, long range cameras), remote detection sensors 203 such as provided by radar or Lidar, proximity or touch sensors 205, and/or sonar sensors (not shown). Additionally, as described with an example of FIG. 1, the collection of sensors can include tire sensors 207.

Each of the sensors 201, 203, 205, 207 can communicate with, or utilize a corresponding sensor interface 210, 212, 214, 216. Each of the sensor interfaces 210, 212, 214, 216 can include, for example, hardware and/or other logical component which is coupled or otherwise provided with the respective sensor. For example, the sensors 201, 203, 205, 207 can include a video camera and/or stereoscopic camera set which continually generates image data of an environment of the vehicle 250. As an addition or alternative, one or more of the sensor interfaces 210, 212, 214, 216 can include a dedicated processing resource, such as provided with a field programmable gate array (“FPGA”) which receives and/or processes raw image data from the camera sensor.

In some examples, the sensor interfaces 210, 212, 214, 216 can include logic, such as provided with hardware and/or programming, to process sensor data 209 from a respective sensor 201, 203, 205, 207. The processed sensor data 209 can be outputted as sensor data 211. As an addition or variation, the control system 100 can also include logic for processing raw or pre-processed sensor data 209.

According to one implementation, the vehicle interface subsystem 290 can include or control multiple interfaces to control mechanisms of the vehicle 250. The vehicle interface subsystem 290 can include a propulsion interface 292 to electrically (or through programming) control a propulsion component (e.g., a gas pedal), a steering interface 294 for a steering mechanism, a braking interface 296 for a braking component, and lighting/auxiliary interface 298 for exterior lights of the vehicle. The vehicle interface subsystem 290 and/or control system 200 can include one or more autonomous controllers 284 which receive one or more commands 285 from the control system 200. The commands 285 can include route information 287 and one or more operational parameters 289 which specify an operational state of the vehicle (e.g., desired speed and pose, acceleration, etc.).

The autonomous controller(s) 284 generate control signals 219 in response to receiving the commands 285 for one or more of the vehicle interfaces 292, 294, 296, 298. The autonomous controllers 284 use the commands 285 as input to control propulsion, steering, braking and/or other vehicle behavior while the autonomous vehicle 250 follows a route. Thus, while the vehicle 250 may follow a route, the autonomous controller(s) 284 can continuously adjust and alter the movement of the vehicle in response receiving a corresponding set of commands 285 from the control system 200. Absent events or conditions which affect the confidence of the vehicle 250 in safely progressing on the route, the control system 200 can generate additional commands 285 from which the autonomous controller(s) 284 can generate various vehicle control signals 219 for the different interfaces of the vehicle interface subsystem 290.

According to examples, the commands 285 can specify actions that are to be performed by the vehicle 250. The actions can correlate to one or multiple vehicle control mechanisms (e.g., steering mechanism, brakes, etc.). The commands 285 can specify the actions, along with attributes such as magnitude, duration, directionality or other operational characteristic of the vehicle 250. By way of example, the commands 285 generated from the control system 200 can specify a relative location of a road segment which the autonomous vehicle 250 is to occupy while in motion (e.g., change lanes, move to center divider or towards shoulder, turn vehicle etc.). As other examples, the commands 285 can specify a speed, a change in acceleration (or deceleration) from braking or accelerating, a turning action, or a state change of exterior lighting or other components. The autonomous controllers 284 translate the commands 285 into control signals 219 for a corresponding interface of the vehicle interface subsystem 290. The control signals 219 can take the form of electrical signals which correlate to the specified vehicle action by virtue of electrical characteristics that have attributes for magnitude, duration, frequency or pulse, or other electrical characteristics.

According to an example of FIG. 2, the control system 200 of the autonomous vehicle 250 includes a route planner 222, event logic 224, and a vehicle control interface 228. The vehicle control 228 represents logic that converts alerts of event logic 224 (“event alert 235”) into commands 285 that specify a vehicle action or set of actions.

In more detail, the route planner 222 can select one or more route segments that collectively form a path of travel for the autonomous vehicle 250 when the vehicle in on a trip. In one implementation, the route planner 222 can specify route segments 231 of a planned vehicle path which defines turn by turn directions for the vehicle at any given time on a trip. The route planner 222 can utilize sensor interface 210 to receive GPS position information as sensor data 211. The vehicle control 228 can process route updates from the route planner 222 as commands 285 to progress along a path or route using default driving rules and actions (e.g., moderate steering and speed).

In some examples, the control system 100 can also include intra-road segment localization and positioning logic (“IRLPL 238”). The IRLPL 238 can utilize sensor data 211 that is in the form of Lidar, stereoscopic imagery, and/or depth sensors. While the route planner 222 can determine the road segments of a road path that the vehicle 250 is to operate on, IRLPL 238 can identify an intra-road location 233 for the vehicle within a particular road segment. The intra-road location 233 can include contextual information, such as marking points of an approaching roadway where potential ingress into the roadway (and thus path of the vehicle) may exist. The intra-road location 233 can be utilized by event logic 224, and/or vehicle control 228, for purpose of detecting potential points of interference or collision on the portion of the road segment in front of the vehicle. The intra-road location 233 can also be used to determine, for example, whether detected objects can collide or interfere with the vehicle 250, and response actions that are determined for anticipated or detected events.

With respect to an example of FIG. 2, the event logic 224 can trigger a response to a detected event. A detected event can correspond to a roadway condition or obstacle which, when detected, poses a potential threat of collision to the vehicle 250. By way of example, a detected event can include an object in the road segment, heavy traffic ahead, and/or wetness or other environmental conditions on the road segment. The event logic 224 can use sensor data 211 from cameras, Lidar, radar, sonar or various other image or sensor component sets in order to detect the presence of such events as described. For example, the event logic 224 can detect potholes, debris, and even objects which are on a trajectory for collision. Thus, the event logic 224 detects events which, if perceived correctly, may in fact require some form of evasive action or planning.

When events are detected, the event logic 224 can signal an event alert 235 that classifies the event and indicates the type of avoidance action which should be performed. For example, an event can be scored or classified between a range of likely harmless (e.g., small debris in roadway) to very harmful (e.g., vehicle crash may be imminent). In turn, the vehicle control 228 determines a response, corresponding to an event avoidance action which the vehicle 250 can perform to affect a movement or maneuvering of the vehicle. By way of example, the autonomous vehicle 250 response can include a slight or sharp vehicle maneuvering for avoidance, using a steering control mechanism and/or braking component. The event avoidance action can be signaled through the commands 285 for autonomous controllers 284 of the vehicle interface subsystem 290.

The grip control logic 226 can process tire sensor data 211T provided from the tire sensor interface 26, as well as RTI information 249 communicated, via the communication interface 220 from a remote source, in order to generate output that influences the operation of the autonomous vehicle 10. The output 223 can, for example, include parameters that affect operation of route planner 222, event logic 224, and/or vehicle control 228. In one implementation, the grip control logic 226 can map a current grip state 215 and grip margin 217 to an anticipated grip value 245 in order to position trigger the vehicle to position itself to avoid or mitigate locations of a road that have bad or dangerous conditions. The anticipated grip value 245 can correspond to, for example, a weight, a scalar, and/or a grip strength or grip margin as determined from the tire sensor of another vehicle. If the comparison is significant, an output 223 of the grip control logic 226 can, for example, include a parameter and/or command for the vehicle control 228 for purpose of path selection or avoidance. In some variations, the output 223 can be communicated to the route planner 222, which may, for example, plan a new route to avoid a road segment that will have a relatively low grip state threshold.

Still further, in some variations, the output 223 can be communicated to, or used to affect operation of the event logic 224. In one implementation, the output 223 affects one or more settings of the event logic 224 affecting a time or distance required for an event response. For example, the output 223 may indicate worsening road condition resulting in less grip margin in an upcoming road segment. To anticipate lower grip margin, the event logic 224 may change settings or otherwise tune to signal event alert 235 earlier, such as when there is less confidence that an event alert is needed.

In some examples, the IRPL 229 provides intra-road locations 233 to the grip control logic 226. The grip control logic 226 synchronizes tire sensor data 211T, or alternatively, information determined from the tire sensor data 211T, so sets of tire sensor data 255 are associated with locations as provided from the IRLPL 238. This can, for example, allow for the tire sensor data 211T to be associated with location information that is granulized to be of an order of a width of tires. In other examples, the position information can be more granular, to cover, for example, a radius of 1-2 feet.

The grip control logic 226 can initiate transmission of a series of synchronized sets of location-specific tire set data 255 to a remote source via the communication interface 220. Each set of location-specific tire set data 255 can provide tire sensor data 211T (e.g., grip state, grip margin) or derivative thereof, correlated to a location where the tire sensor data was recorded by the tire sensors 207. In an example of FIG. 2, the location can be determined from the intra-road location data 233, and thus more granular than would otherwise be provided from a GPS sensor.

Network Service

FIG. 3 is a block diagram that illustrates a server system for providing a network service that utilizes tire sensor data. As described with other examples, a network service can receive and transmit grip values and related information (e.g., RTI information 21) with vehicles for purpose of utilizing tire sensor information

In an embodiment, computer system 300 includes processor 304, memory 306 (including non-transitory memory), storage device 310, and communication interface 318. Computer system 300 includes at least one processor 304 for processing information. Computer system 300 may also include the main memory 306, such as a random access memory (RAM) or other dynamic storage device, for storing information and instructions to be executed by processor 304. Main memory 306 also may be used for storing temporary variables or other intermediate information during execution of instructions to be executed by processor 304. Computer system 300 may also include a read only memory (ROM) or other static storage device for storing static information and instructions for processor 304. The storage device 310, such as a magnetic disk or optical disk, is provided for storing information and instructions. The communication interface 318 may enable the computer system 300 to communicate with other servers or computer entities through use of the network link 320.

Examples described herein are related to the use of computer system 300 for implementing the techniques described herein. According to one embodiment, those techniques are performed by computer system 300, operating as a server in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative aspects, hard-wired circuitry may be used in place of or in combination with software instructions to implement aspects described herein. Thus, aspects described are not limited to any specific combination of hardware circuitry and software.

In an example of FIG. 3, the computer system 300 can receive grip values from a population of vehicles which are equipped in a manner described with FIG. 1 or 2, or in a manner described with other examples. The computer system 300 can operate to wirelessly communicate and receive grip values 303 as measured by tire sensors of various vehicles. The computer system 300 can also store road grip calculation instructions 315, and the processor 304 can execute road grip calculation instructions 315 to generate map data structure that plots received grip values to location (“road surface map 325”). The processor 304 can also execute road grip calculation instructions 315 to determine sets of grip values for various locations of a road network, based in part on measured grip values 303 received over the communication interface 320 from different vehicles. In some variations, the road grip calculation instructions 315 can enable computer system 300 to, for example, extrapolate tire grip values to locations which may not be associated with actually measured tire sensor information. According to some examples, the processor 304 executes the road grip calculation instructions 315 to determine a road surface map 355, which correlates individual locations of a road network with a measured or anticipated set of road grip values.

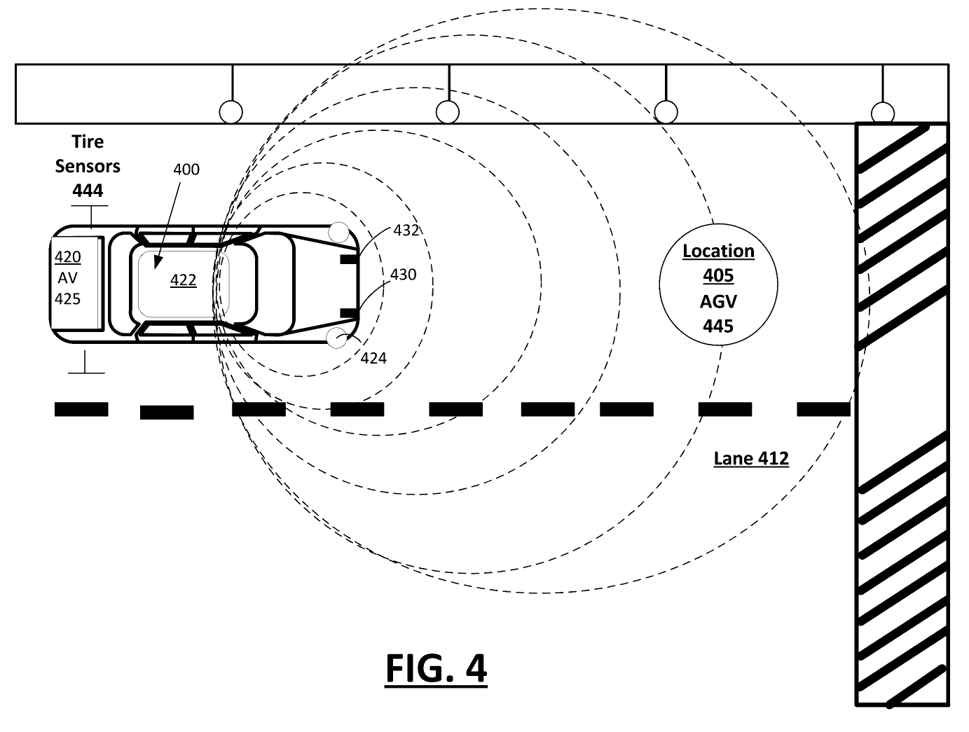

FIG. 4 illustrates an example of an autonomous vehicle that can operate to transmit and receive location-specific tire sensor information. In an example of FIG. 4, an autonomous vehicle 410 includes various sensors, such as roof-top cameras 422, front cameras 424, radar or sonar 430, 432, tire sensors 438, and a set of tire sensors 444. A processing center 425, comprising a combination of one or more processors and memory units can be positioned in a trunk of the vehicle 410.

As described with other examples, the tire sensors 444 can operate to provide tire sensor data (e.g., grip state and grip margin) for a control mechanism of the vehicle 400. Additionally, the vehicle 400 may receive information corresponding to anticipatory grip values 445 for one or more locations of a road segment, such as for a location 405 of an approaching road segment as shown by FIG. 4. The anticipatory grip values 445 can be provided to the vehicle from a remote source, such as a network service. As described with an example of FIG. 3, a network service may communicate with a group of vehicles which provide tire sensor data, from which a road surface map or value set can be determined for a given time period (e.g., 30-minute window). In anticipation of a worsening road condition at location 405, the vehicle can reduce velocity and/or change settings. When the anticipated grip value indicates the vehicle 400 will experience a change in the magnitude of the grip state which is best avoided, one or more functional components of the vehicle control system can be controlled or configured proactively to accommodate the change. For example, other settings, such as planned stopping distance can be increased. Still further, the vehicle 400 can perform lane aversion (e.g., transition into lane 412) if a lane is available in order to avoid a section of road that is particularly bad.

Still further, logical components, such as represented by event logic 224 (see FIG. 2), can be configured based on the anticipated grip values 445 for location 405. For example, if the vehicle 400 anticipated grip values on a road segment that are poor, the event logic 224 (see FIG. 2) can be configured or provided with a setting that causes, for example, an event alert to trigger sooner.

Additionally, the vehicle 400 can communicate grip values to a network service, including grip values of the location 405, as actually measured by the tire sensors of the vehicle 400.

Hardware Diagrams

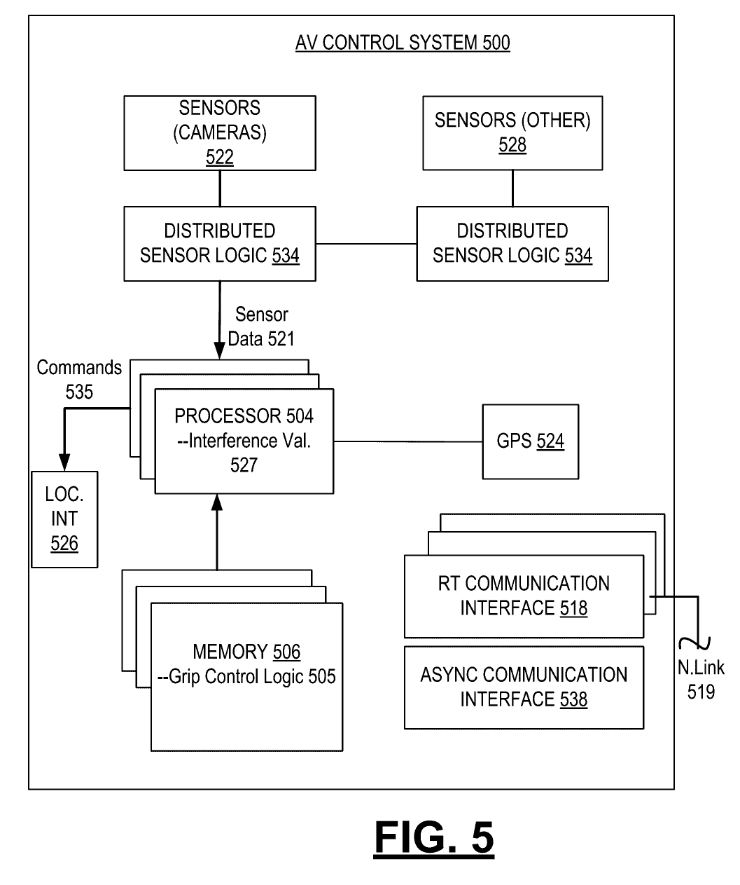

FIG. 5 is a block diagram that illustrates a control system for an autonomous vehicle upon which embodiments described herein may be implemented. An autonomous vehicle control system 500 can be implemented using a set of processors 504, memory resources 506, multiple sensors interfaces 522, 528 (or interfaces for sensors) and location-aware hardware such as shown by GPS 524.

According to some examples, the control system 500 may be implemented within an autonomous vehicle with software and hardware resources such as described with an example of FIG. 2. In an example shown, the control system 500 can be distributed spatially into various regions of a vehicle. For example, a processor bank 504 with accompanying memory resources 506 can be provided in a vehicle trunk. The various processing resources of the control system 500 can also include distributed sensor processing components 534, which can be implemented using microprocessors or integrated circuits. In some examples, the distributed sensor logic 534 can be implemented using field-programmable gate arrays (FPGA).

In an example of FIG. 5, the control system 500 further includes multiple communication interfaces, including one or more multiple real-time communication interface 518 and asynchronous communication interface 538. The various communication interfaces 518, 538 can send and receive communications to other vehicles, central services, human assistance operators, or other remote entities for a variety of purposes. In the context of an example of FIG. 2, the control system 200 can be implemented using the autonomous vehicle control system 500, such as shown with an example of FIG. 5. In one implementation, the real-time communication interface 518 can be optimized to communicate information instantly, in real-time to remote entities (e.g., human assistance operators). Accordingly, the real-time communication interface 518 can include hardware to enable multiple communication links, as well as logic to enable priority selection.

The vehicle control system 500 can also include a local communication interface 526 (or series of local links) to vehicle interfaces and other resources of the vehicle 10. In one implementation, the local communication interface 526 provides a data bus or other local link to electro-mechanical interfaces of the vehicle, such as used to operate steering, acceleration and braking, as well as to data resources of the vehicle (e.g., vehicle processor, OBD memory, etc.).

The memory resources 506 can include, for example, main memory, a read-only memory (ROM), storage device, and cache resources. The main memory of memory resources 506 can include random access memory (RAM) or other dynamic storage device, for storing information and instructions which are executable by the processors 504.

The processors 504 can execute instructions for processing information stored with the main memory of the memory resources 506. The main memory can also store temporary variables or other intermediate information which can be used during execution of instructions by one or more of the processors 504. The memory resources 506 can also include ROM or other static storage device for storing static information and instructions for one or more of the processors 504. The memory resources 506 can also include other forms of memory devices and components, such as a magnetic disk or optical disk, for purpose of storing information and instructions for use by one or more of the processors 504.

One or more of the communication interfaces 518 can enable the autonomous vehicle to communicate with one or more networks (e.g., cellular network) through use of a network link 519, which can be wireless or wired. As described with examples of FIG. 2, the memory 506 can store instructions for implementing grip control logic 505. The grip control logic 505 can enable determination of grip state and grip margin when the vehicle is in operation.

Additionally, the vehicle can receive RTI information 21 (FIG. 1), tire sensor information 31 (FIG. 1), or other information for calculating anticipated grip values for a given segment of roadway. The grip control logic 505 can use externally provided information to calculate or identify anticipated road grip values, for which changes to road or operational conditions may be determined. Additionally, the grip control logic 505 can merge or synchronize anticipated grip value calculations with location information, as determined from the GPS 524 or from other sources. A resulting set of location-specific grip value data set 535 can be sent to, for example, the network service.

Methodology

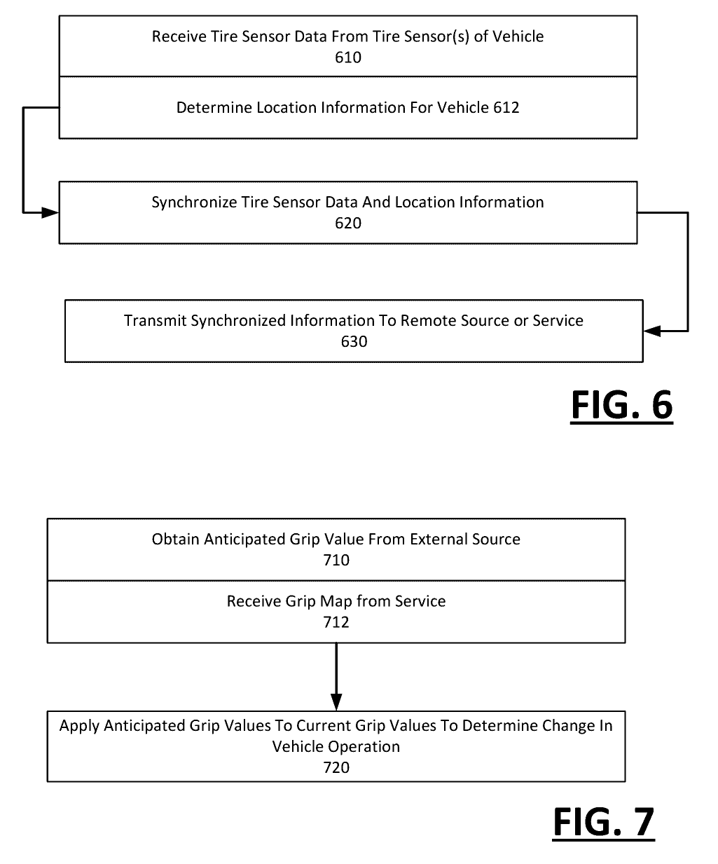

FIG. 6 illustrates a method for operating a vehicle to provide location-specific tire sensor data to a network service. FIG. 7 illustrates a method for operating a vehicle to in a manner that anticipates changes to tire grip. In describing examples of FIG. 6 and FIG. 7, reference may be made to elements of other figures for purpose of illustrating suitable components for performing a step or sub-step being described.

With reference to FIG. 6, a vehicle may operate to receive tire sensor data from one or more tire sensors (610). Among other types of tire sensor data, the tire sensors 1 can be used to determine a grip state 15 and/or grip margin 17 for a corresponding tire. The vehicle may obtain location information while operating and receiving the tire sensor data (612).

The vehicle may synchronize the tire sensor data and the location information, so that data sets are generated which reflect tire sensor values obtained from a particular location by the vehicle's tire sensors (620). The location information can be obtained from resources such as GPS, or alternatively, from intra-road location resources (e.g., see IRLPL 238).

The vehicle can use a wireless communication component to transmit tire sensor data that is synchronized with location information (630). In this way, the vehicle can provide location specific tire sensor information, such as data sets that include a measured or determined grip value and a specific location of a road where the grip value is measured.

With reference to an example of FIG. 7, a vehicle can obtain an anticipated grip value from an external source (710). For example, a vehicle can receive a grip state and/or grip margin, as measured in a relevant time period by another vehicle with similar tires, from a network service that communicates with the vehicle over a wireless communication medium. In some implementations, the anticipated grip values are provided as a road surface map, or as data for populating a road surface map (e.g., updating an existing road surface map) on the vehicle (712). As a road surface map, locations of road segments are mapped to grip values which have been measured on other vehicles, or alternatively, extrapolated from actual measurements of other vehicles.

The anticipated grip values can be applied to current grip values in order to determine or anticipate a change in the vehicle operation (720). The change in the vehicle operation can correspond to vehicle actions that are taken, or alternatively, settings which may be changed should vehicle actions be taken.

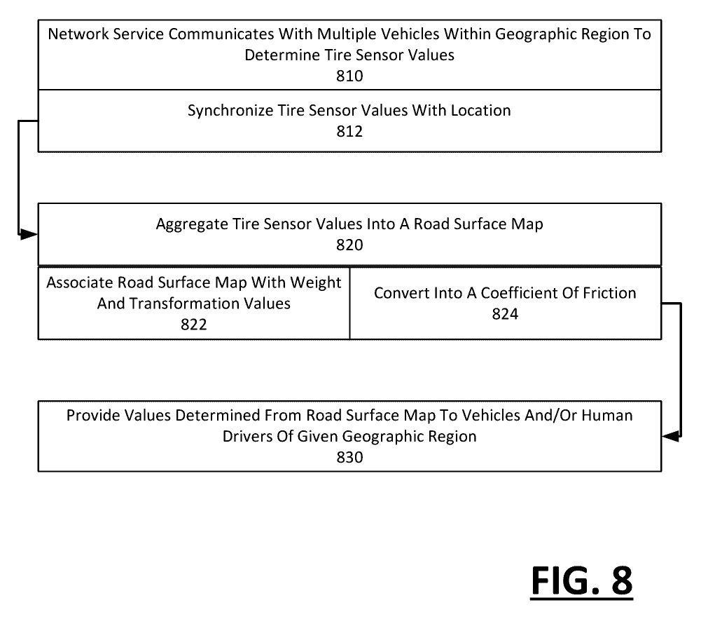

FIG. 8 illustrates an example method for developing a road surface map of a given geographic region, according to one or more examples. In some examples, a method such as described may be implemented using a network service, such as described with an example of FIG. 3. Reference may be made in examples described for purpose of illustrating a suitable component for performing a step or sub-step being described.

In one example, a network service communicates with multiple vehicles of a given geographic region in order to determine tire sensor values from the vehicles (810). The network service may be implemented as, for example, computer system 300, communicating over a wireless network with a fleet of vehicles. In some examples, the vehicles may be autonomous. In variations, some or all of the vehicles that communicate with the network service may be human driven. With, for example, human driven vehicles, the computer system 300 may communicate with mobile devices that are provided within the human driven vehicles and which have access to tire sensor values generated from tire sensors of the respective vehicles.

According to some examples, the tire sensor values are synchronized with the location where a corresponding vehicle made the measurement (812). In some examples, the vehicle measures the tire sensor values and synchronizes the tire sensor values with the current vehicle location before transmitting the data to the network service. The current vehicle location can be determined from, for example, GPS or localization resources of the vehicle. In variations, the network service may separately monitor the location of the vehicle (e.g., track a GPS component of a mobile device) and separately synchronize the tire sensor values.

The network service may normalize the obtained values for factors such as dimension, tread type, weight of vehicle, material type etc (820). The network service may also normalize the tire sensor values for vehicle type and weight. Variations in the roadway condition which can affect the coefficient of friction may also be used to weight the measurements of the tire sensors.

In some examples, the network service may correlate the tire sensor values to measurements for the road segment, such as determinations of the coefficient of friction for a given road segment. Likewise, variations to the surface of roadway (e.g., as a result of precipitation, snow, ice, etc.) can weight the measurements of the tire sensor values.

The network service may aggregate the tire sensor values into a road surface map that represents road segments of the road network for the given geographic region (820). For individual segments of the roadway, an aggregated value may be determined that is based on the aggregation of tire sensor values. Each aggregation may correspond to, for example, an average or weighted average of the average grip value as measured by multiple tire sensors that traverse the road segment.

In variations, the road surface map can include weights or transformation values, that are based on the measured grip values of vehicles that traverse the road segment. The weights or transformation values can represent the surface of the road segment, and specifically, the affect the surface of the road segment may have on an expected grip value of a tire (822). The values may, for example, be affected by conditions of the road surface, such as provided through excessive heat, precipitation, ice or snow.

Still further, in other variations, the network service may transform or convert the measured tire sensor values into a coefficient of friction (or range thereof) (824), based on transformation functions which can account for factors such as tire dimension, tire weight, vehicle weight, tread type, material type and other factors. Still further, for a vehicle, the coefficient of friction for the given road segment can be modeled for using multiple sensor inputs.

The network service may provide values determined from road surface map to vehicles and/or human drivers of the given geographic region, as the vehicles progress through the geographic region (830). For some vehicles, the values of the road surface map provide expected values, which onboard sensors can measure against, in order to update the road surface map and/or normalize the vehicle's measurements with other vehicles. Still further, the values of the road surface map can be provided as instructions (e.g., for autonomous vehicles) or notifications (e.g., for human drivers) from which the vehicles can plan routes (e.g., avoid certain roads) or trajectories (e.g., switch lanes), or take other actions (e.g., change vehicle speed).

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is being claimed is:

1. A method for operating a vehicle, the method comprising:
receiving tire sensor data based on measurements of at least a first tire sensor for a corresponding tire of the vehicle, wherein the tire sensor data indicates grip values that include (i) a grip state of the corresponding tire with respect to an underlying road, and (ii) a grip margin of one or more tires of the vehicle to a grip safety threshold after which the vehicle is deemed unsafely in motion;
while receiving tire sensor data, determining location information for the vehicle; and
synchronizing the location information with the tire sensor data to create location-specific grip values.

2. The method of claim 1, further comprising:
transmitting the location-specific grip values to a network service or to another vehicle.

3. The method of claim 1, further comprising:
determining a road condition characteristic of a road on which the vehicle travels based at least in part on at least one of the grip state or grip margin.

4. The method of claim 3, wherein determining the road characteristic condition is based at least in part on a category of the tire.

5. The method of claim 3, wherein the road condition characteristic is specific to individual locations of the multiple locations.

6. The method of claim 1, wherein each of the plurality of locations is specific to a span that is of an order of error for a Global Positioning System unit of the vehicle.

7. The method of claim 1, wherein each of the plurality of locations is specific to a span that is of an order of a width of a tire.

8. A method for operating a network service for providing vehicle information, the method being implemented by one or more processors and comprising:
receiving tire sensor data communicated from a plurality of vehicles, each vehicle including at least a first tire sensor for a corresponding tire, wherein the tire sensor data is measured by the at least first tire sensor of each vehicle to indicate (i) a grip state of the corresponding tire with respect to an underlying road, and (ii) a grip margin of the corresponding tire to a grip safety threshold after which the vehicle is deemed unsafely in motion;
determining location information for each vehicle that communicates tire sensor data; and
generating a road surface map based on tire sensor data and location information communicated from each of the plurality of vehicles, the road surface map identifying a road grip value reflecting at least one of the grip state or grip margin for at least an individual location of the plurality of locations.

9. The method of claim 8, wherein the road grip value of one or more of the plurality of locations is based on an aggregation of multiple road grip values identified for multiple vehicles.

10. The method of claim 8, wherein the road grip value reflects at least one of the grip state or grip margin for an area that includes multiple locations.

11. The method of claim 8, wherein generating the road surface map includes determining a first road grip value for at least a first location using tire sensor data and location information that is identified as having been measured by a tire sensor of at least a first vehicle at the first location, and extrapolating a second road grip value for at least a second location or area using the first road grip value.

12. The method of claim 8, wherein the road grip value for each location is based on tire sensor data, received from one or more of the plurality of vehicles, that correlates to the location based on the location information determined for each of the one or more vehicles.

13. The method of claim 8, further comprising:
determining a route in progress for a vehicle; and
communicating the road grip value to the vehicle for multiple areas or locations of a portion of the route that is yet to be traversed.

14. The method of claim 13, further comprising:
triggering implementation of one or more operational parameters on the vehicle based on the communicated road grip value for at least one of the multiple areas or locations of the portion of the route.

15. The method of claim 13, further comprising:
providing a recommendation for operating the vehicle in accordance with one or more operational parameters based on the communicated road grip value.

16. The method of claim 14, wherein the one or more operational parameters include a parameter that is based on a stopping distance.

17. The method of claim 14, wherein the one or more operational parameters are based on a turning radius.

18. A non-transitory computer readable medium that stores instructions, which when executed by one or more processors of a computer system, cause the computer system to perform operations that include:
receive tire sensor data based on measurements of at least a first tire sensor for a corresponding tire of the vehicle, wherein the tire sensor data indicates grip values that include (i) a grip state of the corresponding tire with respect to an underlying road, and (ii) a grip margin of one or more tires of the vehicle to a grip safety threshold after which the vehicle is deemed unsafely in motion;
while receiving tire sensor data, determine location information for the vehicle; and
synchronize the location information with the tire sensor data to create location-specific grip values.

19. The non-transitory computer readable medium of claim 18, further comprising instructions, which when executed by the one or more computers, cause the computing system to:
transmit the location-specific grip values to a network service or to another vehicle.

20. The non-transitory computer readable medium of claim 18, further comprising instructions, which when executed by the one or more computers, cause the computing system to:
determine a road condition characteristic of a road on which the vehicle travels based at least in part on at least one of the grip state or grip margin.
